(19) United States
(12) Patent Application Publication
(10) Pub. No.: US 2026/0160683 A1
(43) Pub. Date: Jun. 11, 2026

(54) FLUORESCENCE LIFETIME DETERMINATION

(71) Applicant: The University Court of the University of Glasgow, Glasgow, Strathclyde (GB)

(72) Inventors: Ashley LYONS, Glasgow (GB); Daniele FACCIO, Glasgow (GB); Vytautas ZICKUS, Glasgow (GB); Raul MENDOZA, Glasgow (GB)

(21) Appl. No.: 19/150,136

(22) PCT Filed: Jan. 23, 2024
(86) PCT No.: PCT/EP2024/051509

§ 371 Date: Jul. 22, 2025

(30) Foreign Application Priority Data
Jan. 24, 2023 (GB) 2301005.1

(51) Int. Cl. G01N 21/64

(52) U.S. Cl. CPC G01N 21/6408; G01N 21/6456; G01N 2021/6471; G01N 2201/08

(57) ABSTRACT

An apparatus and method determine a fluorescence lifetime of a sample with a Mach-Zehnder interferometer. A beam splitter interferes a fluorescence signal traveling in a first arm with a frequency-matched reference pulse in a second arm, yielding two combined outputs. A first single-photon detector converts the first output into a signal proportional to its photon count, and a second detector produces an analogous signal for the second output. By correlating the detectors' signals while systematically varying the relative optical path delay between the interferometer arms, the system extracts the fluorescence lifetime of the sample.

### FIELD OF THE INVENTION

The present invention relates to methods, systems and apparatus for determining the fluorescence lifetime of a sample and particularly, although not exclusively, to exploiting Hong-Ou-Mandel interference to determine fluorescence lifetimes with higher resolutions than have been previously achieved.

### BACKGROUND

Fluorescence Lifetime Imaging Microscopy (FLIM) measures the exponential decay time of fluorophores excited by an ultrafast source and has been used across the bio-imaging community to provide information about local biological environments because fluorescence lifetime can be dependent on local pH, temperature, viscosity, and chemical concentrations. Commonly used fluorophores often have fluorescence lifetimes in the range of hundreds of picoseconds up to several nanoseconds. However, the fluorescence lifetimes can be as short as a few tens of femtoseconds depending on the nature of the fluorophore, and its environment.

Current efforts to determine the fluorescent lifetime of fluorophores typically implement time-correlated single-photon counting (TCSPC) devices. Such devices have a time resolution limited to 100 picoseconds or more. This is, in part, because the impulse response function (IRF) of the TCSPC detector is limited by effects such as electron diffusion that affect the operation of the detector itself.

Femtosecond-scale resolutions for fluorescence lifetime determinations have been achieved using nonlinear optical gating methods. However, the low efficiency of nonlinear effects requires the use of high power lasers that have a limited wavelength flexibility within a given system due to the need for phase matching, and the limited availability of suitable nonlinear crystals. For example, Kerr gating techniques have been implemented to achieve femtosecond-sale resolutions with efficiencies reaching only up to 50%.

There is therefore a need for methods, systems, and apparatus suitable for high-efficiency high-resolution fluorescence lifetime determination.

The present invention has been devised in light of the above considerations.

### SUMMARY OF THE INVENTION

In a general sense, the present invention provides a novel configuration for a Mach-Zender interferometer that enables the direct determination of the fluorescence lifetime of a fluorescent sample. This is achieved, in particular, by transmitting photons of a reference pulse through one arm of the Mach-Zender interferometer, and photons of a fluorescence signal through the other arm of the Mach-Zender interferometer. Through suitable selection and control of the reference signal with respect to the fluorescence signal, the present invention can exploit Hong-Ou-Mandel (HOM) interference (also referred to as two-photon interference), which is the physical effect where two indistinguishable photons that meet at opposing faces of a splitting surface of a beam splitter interfere and are output along the same exit path.

Previous attempts to exploit HOM-interference for the purposes of determining fluorescent lifetimes have involved propagating fluorescent photons through both entrance arms of an interferometer, and cross-correlating the output with a subsequent output arising from a later laser pulse propagated through both entrance arms of the interferometer. However, extracting the fluorescence time from this cross-correlation is known to be an ill-posed inverse problem. In other words, there are many different combinations of input intensity patterns that can be cross-correlated to arrive at the same cross-correlation function. Accordingly, it may not be possible to determine the fluorescence lifetime of a sample without conducting further measurements, or making strongly limiting assumptions about the fluorescent-decay profile of the sample.

The present invention, in contrast, provides an apparatus that can be used in accordance with the methods disclosed herein to determine a correlation function from which the fluorescence lifetime of the sample can be directly retrieved quickly and efficiently with certainty, high-precision, and higher resolution than has been previously achieved in similar pre-existing systems.

The invention is set out in the appended set of claims.

In a first aspect, there is provided an apparatus for determining a fluorescence lifetime of a sample. The apparatus comprises a Mach-Zender interferometer. The Mach-Zender interferometer comprises: a first arm for conveying a fluorescence signal from the sample; a second arm for conveying a reference pulse, wherein the reference pulse has a frequency selected to interfere with the fluorescence signal; a delay mechanism configured to control a relative path delay between the first and second arms; and a beam splitter having a first input connected to the first arm, a second input connected to the second arm, a first output configured to emit a first combined signal, and a second output configured to emit a second combined signal. The apparatus further comprises: a first photon detector connected to the first output so as to receive the first combined signal and output a first detection signal indicative of the number of photons in the first combined signal; a second photon detector connected to the second output so as to receive the second combined signal and output a second detection signal indicative of the number of photons in the second combined signal; and a lifetime determination unit connected to the first and second photon detectors, wherein the lifetime determination unit is configured to determine the fluorescence lifetime of the sample based on a correlation between the first and second detection signals over a range of relative path delays between the first and second arms.

This apparatus may be used to determine the fluorescence lifetime of a sample by adjusting a time delay between the arrival of the reference pulse and the fluorescence signal at the beam splitter. In this way, photons in the reference pulse may interfere with photons in the fluorescence signal that have been emitted from the sample at a different time in the sample's fluorescence lifetime. Unlike conventional implementations of a Mach-Zender interferometer that provide meaningful output based on a phase difference between signals propagating through different arms of the interferometer, the apparatus described here provides the user with an ability to determine fluorescence lifetimes of samples irrespective of phase differences between the arms.

This apparatus may be used, in accordance with the methods disclosed herein, to determine the fluorescence lifetime of a sample very quickly. For example, the apparatus may be usable to determine a fluorescence of a lifetime over a total acquisition period of 5 seconds or less, 10 seconds or less, 20 seconds or less, 30 seconds or less or 60 seconds or less. The total acquisition period may be considered to be an aggregate of a plurality of detection periods, each detection period being an amount of time over which the first and second photon detectors receive the first and second combined signals for a given path delay between the first and second arms of the Mach-Zender interferometer.

As discussed above, the determination of the fluorescence lifetime of the sample may be based on determining a correlation function between the signals detected by the first and second photon detectors of the apparatus as a function of the delay between the reference pulse and the fluorescence signal (i.e., the delay between the arms of the Mach-Zender interferometer). This delay may be adjusted by adjusting the timing at which the reference pulse and fluorescence signal arrive at the beam splitter of the interferometer.

However, it may be preferable—and, importantly, easier to implement with a greater degree of accurate control—to adjust this delay by adjusting the path length of one or both of the first and second arms. By increasing the length of one of the entrance paths relative to the other, a delay may be introduced between the reference pulse and the fluorescence signal, thereby facilitating the determination of the correlation function across a range of time delays.

In some examples, only the first or only the second arm may be adjustable, while in other examples, both arms may be adjustable.

In a practical example, it may be preferable to only adjust one of the arms to reduce the risk of mis-aligning the Mach-Zender interferometer by “walking” the beam path off alignment by repeatedly adjusting both arms in the same direction.

In some embodiments, the reference pulse may have a duration that is shorter than the fluorescence lifetime to be determined.

In some examples, the duration of the reference pulse may be at least 10 times shorter than the fluorescence lifetime. In this way, the resolution of the fluorescence lifetime determination may be maximised.

In other examples, the duration of the reference pulse may be only slightly shorter than (e.g. between 85% and 95% of) the fluorescence lifetime. In this way, there may be an optimum trade-off between resolution of the fluorescence lifetime determination and confidence that the true fluorescence lifetime has been identified from the correlation between the first and second detection signals.

Further, this apparatus may be used, in accordance with the methods disclosed herein, to determine the fluorescence lifetime of a sample with high precision. For example, the standard deviation in the determined fluorescence lifetime may be 10 picoseconds or less, 5 picoseconds or less, 2.5 picoseconds or less, 1 picosecond or less, 500 femtoseconds or less, 250 femtoseconds or less, 100 femtoseconds or less, 75 femtoseconds or less, 50 femtoseconds or less, or even 10 femtoseconds or less.

Further, this apparatus may be used, in accordance with the methods described herein, to resolve very short fluorescence lifetimes. For example, the apparatus may be usable to determine a fluorescence lifetime of 30 picoseconds or less, 20 picoseconds or less, 10 picoseconds or less, 5 picoseconds or less, 1 picosecond or less, 500 femtoseconds or less, 100 femtoseconds or less, or even 50 femtoseconds or less.

In such examples, the duration of the reference pulse may be 1 picosecond or less, 500 femtoseconds or less, 200 femtoseconds or less, 100 femtoseconds or less, 50 femtoseconds or less, or even 5 femtoseconds or less.

In some embodiments, the lifetime determination unit may comprise: a correlator connected to the first and second detectors, the correlator being configured to determine a correlation function of the first detection signal and the second detection signal.

Determining the correlation function of the first detection signal and the second detection signal may allow the fluorescence lifetime of the sample to be readily extracted from the correlation function.

The correlator may be single photon counting unit or a similar device configured to combine measurements of intensity determined by the first and second detectors. In this way, it may be possible to quantify the amount photons that underwent HOM-interference as a function of the time delay between the first and second entrance paths. This determined relationship between HOM-interference and time delay may then be used to determine the fluorescence lifetime of the sample.

In some embodiments, the correlation function may be a second-order correlation function.

A second-order correlation function may be more suitable than a first-order correlation function, because a second-order correlation function captures the correlation between the intensities of the two different signals being correlated. In contrast a first-order correlation function captures the correlation between the amplitude of said signals. In the context of determining fluorescence lifetimes, a first-order correlation function may offer a non-unique solution—such as those seen in the prior art—and, therefore, a second-order correlation function may provide a user with the certainty that the determined fluorescence lifetime is the true fluorescence lifetime of the sample.

Determining the correlation function of the intensity of the first detection signal with the intensity of the second detection signal (each intensity being a measurement indicative of the intensity of HOM-interfered photons) may be particularly advantageous, because the fluorescence lifetime of the sample may be readily extracted from the correlation function, for example, by extracting a decay constant of an exponentially decaying element of the correlation function. This offers the user certainty, unlike in the cases described above in relation to the prior art wherein it is clear that previously attempted correlations did not offer unique solutions when trying to determine fluorescence lifetimes.

In some embodiments, the first arm and the second arm may each comprise a respective optical fibre.

Optical fibres may be preferable to free-space propagation because optical fibres have lower losses which may be critically important where the number of photons being emitted (such as the number of photons being emitted by a small fluorescent sample) is low. As such, the low losses associated with implementing optical fibres may enable the apparatus described herein to be used to determine the fluorescent lifetime of very small samples, e.g., nanoscale samples.

In some examples, only one of the first and second arms may be defined by an optical fibre.

In a particularly effective example, all of the inputs and outputs of the beam splitter may be connected to an optical fibre.

In some embodiments, the first arm may comprise a first fibre coupler configured to couple the fluorescence signal into the corresponding optical fibre, and the second arm may comprise a second fibre coupler configured to couple the reference pulse into the corresponding optical fibre.

In other words, a first fibre coupler may be configured to couple light (e.g., the fluorescence signals) into the first arm. Similarly, a second fibre coupler may be configured to couple light (e.g., the reference pulse) into the second arm.

Fibre couplers may be provided to minimise losses associated with the reference pulse and fluorescence signal entering optical fibres that define the first and second arms.

In some embodiments, the delay mechanism may comprise at least one of the first and second fibre couplers mounted on a translation stage.

A fibre coupler mounted on a translation stage may also be adjustably attached to a corresponding optical fibre such that moving the fibre coupler back and forth with the translation stage may correspondingly increase and decrease the amount of optical fibre that defines the corresponding entrance path. By implementing the adjustability of the path length of the entrance path in this way, it may be possible to adjust the path length in a way that minimises the risk of mis-aligning the Mach-Zender interferometer.

In some embodiments, the first combined signal may be conveyed from the beam splitter to the first photon detector by an optical fibre, and the second combined signal may be conveyed from the beam splitter to the second photon detector by an optical fibre.

In some embodiments, at least one of the optical fibres may be a single-mode polarisation-maintaining fibre.

Single-mode polarisation-maintaining fibres ensure that the photons entering and exiting those fibres enter into, propagate through, and exit from the fibre in a specific linear polarisation state. In the context of the apparatus and methods disclosed herein, this may be particularly useful because it is a requirement of HOM-interference that the two photons interfering at the beam splitter are completely indistinguishable. This requirement of indistinguishability includes that the polarisation of the two photons should be indistinguishable (i.e., be the same). This identical polarisation, while achievable by other means, may be preferentially achieved by providing single-mode polarisation-maintaining fibres to ensure that the reference pulse and fluorescence signal, and the interfered photons all propagate with the same linear polarisation.

In a particularly effective example, both of the arms of the Mach-Zender interferometer may be defined by a single-mode polarisation-maintaining fibre, wherein said fibres are configured to ensure that at least the reference photons and fluorescence photons (and preferably also the interfered photons) propagate with the same polarisation. In some examples, the optical fibres connecting the beam splitter to the first and second photon detectors may also be single-mode polarisation-maintaining fibres.

In some embodiments, the apparatus may further comprise first and second spectral filters configured to selectively tune the wavelength of the respective signals conveyed towards the beam splitter via the first and second arms. The first and second spectral filters may preferably be configured to selectively tune the wavelength of the respective signals to the same wavelength.

Spectral filters such as those introduced above may be configured to selectively pass only a narrow bandwidth of light, i.e., they may only pass photons having a wavelength in a narrow range of wavelengths. As discussed above in relation to polarisation, HOM-interference requires that the two interfering photons are indistinguishable. Therefore, it is preferable that the only elements of the reference pulse and fluorescence signal that reach the beam splitter of the Mach-Zender interferometer to be interfered have the same frequency and wavelength. As such, by providing identical (or functionally identical) spectral filters at the beginning of the first and second arms, the likelihood of successful HOM-interference at the beam splitter can be increased, thereby improving the operating performance of the apparatus described herein when used to determine fluorescence lifetimes of samples in accordance with the methods described herein.

In some embodiments, the apparatus may further comprise a reference light source configured to emit the reference pulse.

It may be preferable to install a reference light source together with the apparatus to ensure that the light source is consistently and correctly aligned with the Mach-Zender interferometer.

Preferably, the reference light source emits light across a bandwidth that includes at least one of the fluorescing wavelengths of the sample to improve the likelihood of successful HOM-interference.

In some embodiments, the apparatus may further comprise an excitation light source configured to emit an excitation pulse along an input beam path for inducing fluorescence in the sample.

Similarly, it may be preferable to install an excitation light source to ensure that the excitation light source is consistently focused on a predefined sample area of the apparatus. This sample area can then be aligned with the first arm of the Mach-Zender interferometer to ensure that the fluorescence signal is consistently and correctly aligned with the Mach-Zender interferometer.

Preferably, the excitation light source emits light across a bandwidth that includes at least one wavelength that will induce fluorescence at a wavelength that is within the bandwidth of the reference light source.

In some embodiments, the fluorescence signal may be conveyed from the sample to the first arm along the input beam path.

In other words, the path from the sample to the first arm may, at least in part, share a common path with that from the excitation light source to the sample. This may also be referred to as a confocal geometry. A confocal geometry may be preferable because it may represent a more efficient use of space than a non-confocal geometry. Accordingly, it allows for the apparatus to be made smaller, and thus less cumbersome for a user.

In some embodiments, the apparatus may further comprise a dichroic filter on the input. The dichroic filter may be configured to prevent the excitation pulse from propagating into the first arm, and to allow the fluorescence signal to propagate into the first arm.

By providing a dichroic filter (e.g., a dichroic beam splitter), it may be possible to filter away stray light from the excitation pulse to ensure that only photons from the fluorescence signal propagate through the first arm of the Mach-Zender interferometer to arrive at the beam splitter. In this way, the noise detected by the first and second photon detectors will be reduced because stray light will not reach the detectors.

Additionally, the excitation pulse will typically have a shorter wavelength than the reference pulse and fluorescence signal. In other words, each individual photon of the excitation pulse will have a higher energy than the photons of the reference pulse and fluorescence signal, in accordance with the Planck energy-frequency relation. In this case, it may be preferable to prevent these high-energy photons from reaching the first and second photon detectors because they could damage the detectors, e.g., by burning spots into their imaging area.

In some embodiments, the reference light source and the excitation light source may be a common light source.

It may be preferable for the reference light source and the excitation light source to be a single common light source to ensure that both the reference pulse and the excitation pulse propagate in the same polarisation (to promote more efficient HOM-interference).

In some examples, in order to provide the excitation pulse with the frequency needed to induce fluorescence, a frequency-converter such as a non-linear crystal may be provided to frequency-convert (e.g., frequency-double, or even frequency-triple) light having the same wavelength as the reference pulse into a higher-frequency excitation pulse.

In some embodiments, the reference and/or excitation light source may be a single photon source.

A single photon source may be advantageous because it may be possible to reduce the noise collected by the first and second detectors by only propagating one reference photon for every fluorescence photon. Such a configuration may be suitable when low noise is a key consideration, albeit at the expense of the duration of the collection run (more time may be required to collect sufficient data to determine the fluorescence lifetime of the sample)

In some embodiments, the reference and/or excitation light source may be a laser.

Lasers may be highly suitable for the apparatus disclosed herein because they are highly reliable, tunable, coherent light sources with demonstrated versatility and reliability. Lasers as light sources may be a suitable configuration when fast determination of the fluorescence lifetime is needed, although spectral filters may then be needed, in some examples, to reduce the amount of noise picked up by the first and second detectors.

In some embodiments, the first arm may be configured to convey the fluorescence signal towards a first face of a splitting surface in the beam splitter; the second arm may be configured to convey the reference pulse towards a second face of the splitting surface in the beam splitter. The beam splitter may be configured to interfere the reference pulse and the fluorescence signal and the first and second combined signals may comprise interfered photons emitted from the first and second faces of the splitting surface respectively.

In other words, the components of the apparatus may be specifically arranged to promote HOM-interference between the reference pulse and the fluorescence signal. In such instances, the first and second faces of the splitting surface may define opposing faces of said splitting surface.

In another aspect, there is provided a method of determining a fluorescence lifetime of a sample, the method comprising: receiving, at a beam splitter along a first arm of an interferometer, a fluorescence signal from the sample; and receiving, at the beam splitter along a second arm of the interferometer, a reference pulse. The reference pulse has a frequency selected to interfere with the fluorescence signal. The method further comprises interfering, by the beam splitter, the fluorescence signal with the reference pulse. The beam splitter outputs a first combined signal from first output and a second combined signal from a second output. The method further comprises: outputting, by a first photon detector that receives the first combined signal, a first detection signal indicative of the number of photons in the first combined signal; outputting, by a second photon detector that receives the second combined signal, a second detection signal indicative of the number of photons in the second combined signal; and determining, the fluorescence lifetime of the sample based on a correlation between the first and second detection signals over a range of relative path delays between the first and second arms of the interferometer.

By adjusting a time delay between the arrival of the reference pulse and the fluorescence signal at the beam splitter (e.g., at opposing faces of a splitting surface of the beam splitter), it is possible to scan across the time during which a sample is fluorescing. By adjusting a time delay between the arrival of the reference photons and the fluorescence photons that have been emitted from the sample at a different time in the sample's fluorescence lifetime, it is possible to determine how the correlation function between the first and second intensities changes over the course of the fluorescing lifetime of the sample. In this way, the duration of the lifetime can be accurately, efficiently, and quickly extracted from the correlation function by examining how said function varies over a range of different delay times (a delay time, in this application, meaning the difference in time between the arrival of the reference pulse and the first fluorescence signal in the fluorescing lifetime of the sample).

In some embodiments, determining the fluorescence lifetime of the sample comprises determining a correlation function of the first detection signal with the second detection signal.

As discussed above, determining the correlation function of the first intensity with the second intensity where the photons have propagated through a beam splitter and undergone HOM-interference between the reference pulse and the fluorescence signal, (each intensity therefore being a measurement of the intensity of HOM-interfered photons), enables the fluorescence lifetime of the sample emitting the fluorescence photons to be easily extracted. Determining the correlation function based on the detected HOM-interfered photons (when interfered in the way prescribed by the apparatus and methods described herein), provides a correlation function from which the fluorescence time can be determined with certainty, unlike in the cases described above in relation to the prior art wherein it is clear that previously attempted correlations did not offer unique solutions when trying to determine fluorescence lifetimes.

In some embodiments, the correlation may be a second-order correlation function.

As discussed above, a second-order correlation function may be more suitable than a first-order correlation or an autocorrelation function, because a second-order correlation function captures the correlation between the intensities of two different signals, while a first-order correlation function captures the correlation between the amplitude of said signals. In the context of determining fluorescence lifetimes, a first-order correlation function or an autocorrelation may offer a non-unique solution—such as those seen in the prior art—and, therefore, a second-order correlation function may provide a user with the certainty that the determined fluorescence lifetime is the true fluorescence lifetime of the sample.

In some embodiments, the determined correlation function may comprise an exponentially decaying element, and the determined fluorescence lifetime of the sample may be determined based on a decay constant of the exponentially decaying element.

An exponentially decaying element of the correlation function may map precisely onto the exponential decay time that is equivalent to a fluorescence lifetime of the sample according to a relationship or equation that may be determined by a user of the methods and apparatus disclosed herein. This exponentially decaying element may offer the user certainty that the solution for the determined fluorescence lifetime retrieved from the correlation function is the true fluorescence lifetime of the sample.

In another aspect, there is provided a method of determining a property of a fluorescent sample, the method comprising: determining a fluorescence lifetime of the fluorescent sample according to the methods described herein; and determining the property of the fluorescent sample based on the determined fluorescence lifetime.

In some embodiments, the determined property may be one or more of the properties selected from the group comprising: pH, temperature, viscosity, and chemical concentration.

Some properties of a sample, such as its pH, temperature, viscosity, and/or chemical concentration may have an impact on the fluorescent lifetime of the sample. For example, the fluorescent lifetime of a sample may increase with the sample's viscosity for certain samples. By determining physical and/or chemical properties of samples based on their fluorescent lifetime (where the fluorescent lifetime is determined in accordance with the methods disclosed herein), it is possible to determine the physical and/or chemical properties of nanoscale samples non-invasively. Non-invasive measurement of nanoscale samples may be particularly advantageous because invasive measurement techniques may disrupt the sample, thereby reducing the accuracy of the measurement. Further, in the context of biological samples, invasive measurement techniques could risk disrupting the biological processes of those samples, or even killing the samples. Therefore, there is a need for non-invasive measurement techniques such as those provided by the methods disclosed herein.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows a schematic of an apparatus for use in determining the fluorescence lifetime of a sample.

FIG. 2 shows a method for determining the fluorescence lifetime of a sample.

FIG. 3 shows an example of a typical correlation function obtainable by the correlator in FIG. 1.

FIG. 4a shows a fluorescence lifetime curve for a 4-DASPI sample determined based on a correlation function obtained from the correlator of FIG. 1, using a detection time of 2 seconds per delay point, and a step size of 16.7 femtoseconds between adjacent delay points.

FIG. 4b shows a fluorescence lifetime curve for the same 4-DASPI sample as plotted in FIG. 4a determined based on a correlation function obtained from the correlator of FIG. 1, wherein the total acquisition time of the entire correlation function was 3.5 seconds.

FIG. 4c shows a distribution of retrieved lifetimes for 300 fluorescence lifetimes determined using the same parameters as for the fluorescence lifetime curve shown in FIG. 4b.

FIG. 4d shows a determined relationship between the standard deviation of the determined fluorescence lifetime and the total measurement acquisition time.

FIG. 5a shows a plot demonstrating the effect of spectral filtering for two different bandwidths, as applied to an Allura Red sample.

FIG. 5b shows a plot indicating how the pulse duration of a reference beam affects the visibility of interference fringes output from the Mach-Zender interferometer of FIG. 1, and a relationship between the pulse duration of the reference beam and the ratio of fluorescence lifetime-to-pulse duration.

FIG. 5c shows a plot indicating a relationship between the fluorescence lifetime of the sample and the visibility of interference fringes output from the Mach-Zender interferometer of FIG. 1.

FIG. 6 shows fluorescence lifetime estimations of different samples.

FIG. 7 shows a method of determining physical properties of a fluorescent sample non-invasively.

FIG. 8 shows a plot demonstrating the utility of fluorescence lifetime as a viscosity probe for a sample of 4-DASPI mixed with glycerol.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

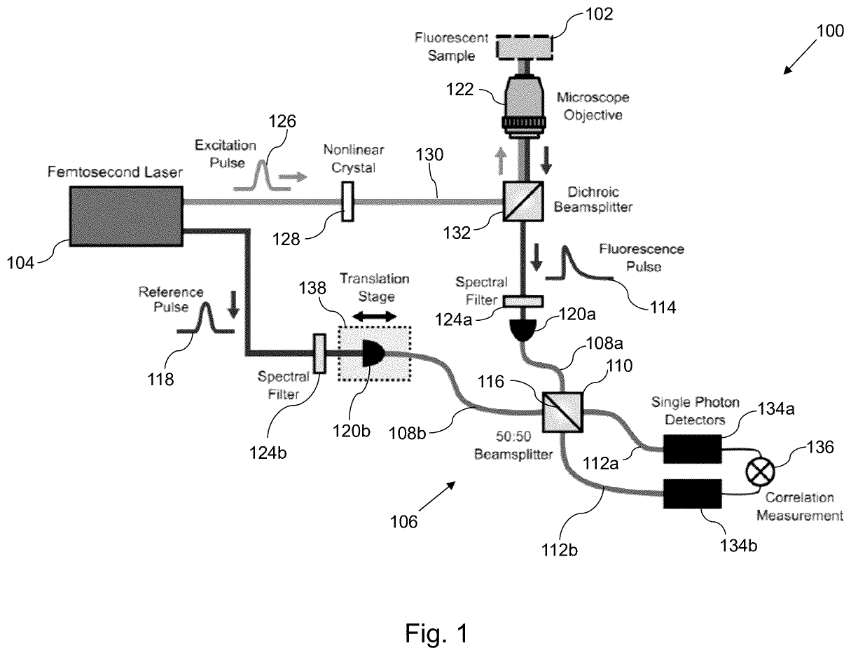

FIG. 1 shows a schematic of an apparatus 100 for use in determining the fluorescence lifetime of a sample.

The apparatus 100 comprises a stage 102 for a fluorescent sample, and a light source 104, and a Mach-Zender interferometer 106 that is configured to receive light from a fluorescent sample mounted on the stage 102, and from the light source 104. In some examples, the light source 104 may be a single photon source, while in other examples, the light source 104 may be a laser.

The Mach-Zender interferometer 106 comprises a first and second arms 108a, 108b, a beam splitter 110, and first and second exit legs 112a, 112b. Each of the arms and exit legs 108a, 108b, 112a, 112b may be defined by an optical fibre, and preferably a single-mode polarisation-maintaining optical fibre. The first arm 106a is arranged to receive a fluorescence signal 114 comprising fluorescence photons and propagate that fluorescence signal 114 to a first input of the beam splitter, wherefrom it is incident on a first face of a splitting surface 116 of the beam splitter 110. Meanwhile, the second arm 108b is arranged to receive a reference signal 118 comprising reference photons and propagate that reference signal 118 to a second input of the beam splitter 110, wherefrom it is incident on a second face of the splitting surface 116 of the beam splitter 110. Said first and second faces of the splitting surface are mutually opposing faces, i.e., they define opposite sides of the splitting surface 116.

In use, the Mach-Zender interferometer 106 is configured to receive, via the first arm 108a, at the first face of the splitting surface 116 of the beam splitter 110, fluorescence photons that are part of the fluorescent signal 114 emitted from a sample mounted on the stage 102). Simultaneously, the Mach-Zender 106 is also configured to receive, via the second arm 108b, at the second face of the splitting surface 116 of the beam splitter 110, reference photons that are part of the reference pulse 118 emitted from the light source 104.

At the splitting surface 116 of the beam splitter 110, where a reference photon is received simultaneously with a fluorescence photon, that pair of photons may undergo Hong-Ou-Mandel (HOM), or two-photon, interference. The key conditions for HOM interference are that the two photons being interfered arrive simultaneously at opposing faces of the splitting surface of a beam splitter and that the two photons being interfered are indistinguishable. For the two photons to be indistinguishable, said photons must at least have (i) the same spatial extent, (ii) the same temporal extent, (iii) the same polarisation, and (iv) the same frequency.

Accordingly, further elements and configurations of the apparatus 100 will now be described that contribute to improving the indistinguishability of the fluorescence and reference photons received at the splitting surface 116 of the beam splitter 110.

The spatial extent of the photons in the fluorescence signal 114 and the reference pulse 118 can be made indistinguishable by feeding the fluorescence photons of the fluorescence signal 114 into the first arm 108a via a first fibre coupler 120a and by providing the first arm 108a as a single-mode optical fibre; and by feeding the reference photons of the reference pulse 118 into the second arm 108b via a second fibre coupler 120b and by providing the second arm 108b as a single-mode optical fibre identical to the single-mode optical fibre defining the first entrance path 108a. The first and second fibre couplers 120a, 120b ensure that the reference photons and the fluorescence photons are efficiently coupled into the optical fibres defining the first and second arms 108a, 108b. Further, by defining the first and second arms 108a, 108b with identical single-mode optical fibres, it is ensured that the transverse profile (i.e., the spatial extent) of the reference photons and the fluorescence photons are the same, thereby contributing to the indistinguishability of the reference photons and the fluorescence photons.

Additionally, ensuring the same spatial extent for the reference photons and the fluorescence photons may require the fluorescence signal 114 and the reference pulse 118 to enter their respective fibre couplers 120a, 120b with identical transverse profiles. In some examples, this identical transverse profile may be a collimated profile (i.e., a transverse profile that is neither increasing nor decreasing with propagation distance). A collimated profile may be particularly suitable because it is more straightforward to verify that two collimated profiles are identical than it is to verify that two non-collimated profiles are identical. Further, by coupling collimated light into the first and second fibre couplers 120a, 120b, more freedom is afforded to the user of the apparatus 100, because it does not matter how far away the sample mounted on the stage 102 is from the first fibre coupler 120a, and how far away light source 104 is from the second fibre coupler 120b. To achieve collimated profiles, an objective lens 122 may be provided between the stage 102 and the first fibre coupler 120a, with the lens 122 positioned such that the distance between the stage 102 and the lens 122 is equal to the focal length of the lens 122. This ensures that the fluorescence signal 114 is collimated between the lens 122 and the first fibre coupler 120a. Similarly, a lens (not shown) may be provided between the light source 104 and the second fibre coupler 120b to achieve collimation. In some examples, any one or more of the lenses used in the apparatus 100 may be a microscope objective lens. Alternatively, the light source 104 may be a collimated light source, such as a laser, and therefore not require a collimating lens between the light source 104 and the second fibre coupler 120b.

The temporal extent of the photons in the fluorescence signal 114 and the reference pulse 118 can be made indistinguishable by ensuring that the fluorescence signal 114 and the reference pulse 118 are both propagated through media for which they have the same group velocity. In other words, it is preferable that the fluorescence signal 114 and the reference pulse 118 propagate through identical arms 108a, 108b and have the same wavelength while they propagate therethrough. By providing identical single-mode optical fibres (as discussed above), it is ensured that the first and second arms 108a, 108b are identical. Achieving identical wavelength for the reference pulse 114 and the fluorescent light 118 will be discussed further below. In effect, achieving indistinguishable temporal extent may be achieved as a by-product of satisfying the other three criteria of indistinguishable spatial extent, polarisation, and frequency.

The polarisation of the photons in the fluorescence signal 114 and the reference pulse 118 can be made indistinguishable by defining the first and second arms 108a, 108b with identically configured polarisation-maintaining optical fibres. In this way, it is possible to ensure that only reference photons and fluorescence photons that have identical polarisations arrive at the splitting surface 116 of the beam splitter 110, thereby improving the indistinguishability of the reference photons and the fluorescence photons.

When combined with the need to achieve identical spatial extent, it can therefore be seen that it is preferable to define the first and second arms 108a, 108b with identical single-mode polarisation-maintaining optical fibres.

The frequency of the photons in fluorescence signal 114 and the reference pulse 118 can be made indistinguishable by providing identical spectral filters 124a, 124b. In other words, a first spectral filter 124a may be provided between the stage 102 and the first fibre coupler 120a (and, where applicable, between the lens 122 and the first fibre coupler 120a), and a second spectral filter 124b may be provided between the light source 104 and the second fibre coupler 120b. The first and second spectral filters 124a, 124b are configured to selectively pass a narrow spectral band, and prevent any light having a wavelength outside the narrow spectral band from propagating through either of the first and second arms 108a, 108b. In this way, the likelihood that a pair of photons (comprising one reference photon and one fluorescence photon) simultaneously arrive at opposing faces of the splitting surface 116 of the beam splitter 110 with the same frequency (or equivalently, in the systems described herein, with the same wavelength) is increased. This consequently improves the indistinguishability of the reference photons and the fluorescence photons being interfered at the beam splitter 110, thereby improving the performance of the apparatus 100.

In order to induce fluorescence, a light source may be provided to shine an excitation pulse 126 having an appropriate wavelength on a sample mounted on the stage 102. Preferably, this excitation pulse 126 induces fluorescence in the sample that is defined by the fluorescence signal 114 that has a wavelength within the bandwidth of the reference pulse 118, and that can be selectively passed by the first spectral filter 124a.

In some examples, the excitation light source may the same light source as the light source 104 that emits the reference pulse 118. In such examples, it may be necessary to frequency up-convert the excitation pulse 126 using a non-linear optical element 128 into an appropriate frequency that characterises a fluorescence-inducing pulse 130. In some examples, the non-linear optical element 128 may be a non-linear crystal for use as a frequency converter (e.g., a barium borate, BBO, crystal).

In order to increase the efficiency with which the fluorescence is induced in the sample, it may be preferable to focus the fluorescence pulse 130 onto the sample. This may be achieved by use of the same lens 122 as used to collimate the fluorescent signal 114 emitted from the sample when the propagation paths for the fluorescent signal 114 and the fluorescence-inducing pulse 130 are arranged in a confocal geometry. Alternatively, where a non-confocal geometry is employed, a separate lens from the collimating lens 122 may be used to focus the fluorescence-inducing pulse 130 onto the sample.

In use, it may be preferable to prevent the fluorescence-inducing pulse 130 from entering the first arm 108a of the Mach-Zender interferometer 106, or indeed from being incident upon any of the beam splitter 110, first fibre coupler 120a, or first spectral filter 124a. As the fluorescence-inducing pulse 130 has a frequency higher than that of the fluorescent light 118, the energy of the photons in the fluorescence-inducing pulse 130 have a correspondingly higher energy. Accordingly, there may be a risk that these higher-energy photons could compromise the overall quality of the recorded signal if they are detected at the output, or could even damage some of the elements through which the fluorescent light 114 is arranged to propagate. Further, allowing the fluorescence-inducing pulse 130 to propagate through the Mach-Zender interferometer 106 could lead to increased noise in the eventually detected signals.

The fluorescence-inducing pulse 130 can be prevented from entering the Mach-Zender interferometer by providing a dichroic filter 132 configured to reflect light having shorter wavelengths (e.g., the fluorescence-inducing pulse 130) while passing light having longer wavelengths (e.g., the fluorescent light 118). In some examples, the dichroic filter 132 may, for example, be a dichroic beam splitter, as shown in FIG. 1.

Provided that at least some of the fluorescence photons arriving at the first face of the splitting surface 116 of the beam splitter 110 arrive simultaneously with and indistinguishable from reference photons arriving at the second face of the splitting surface 116 of the beam splitter 110, pairs of reference and fluorescence photons that are indistinguishable will undergo HOM-interference. As a consequence of this, either both the reference and the fluorescence photons will leave the beam splitter 110 via first output connected to the first exit leg 112a, or both the reference and the fluorescence photons will leave the beam splitter 110 via a second output connected to the second exit leg 112b.

At the end of the first and second exit legs 112a, 112b are respectively provided first and second photon detectors 134a, 134b configured to detect photons that are propagated through the corresponding exit peg 112a, 112b. Each photon detector 134a, 134b may be any suitable photon detector, for example, a single photon avalanche diode (SPAD) detector or an arrayed SPAD detector (i.e. containing multiple SPAD pixels), or a superconducting nanowire single photon detector (SNSPD). The photon detectors 134a, 134b may be selected to be devices that are particularly sensitive to photons having a wavelength corresponding to the wavelength(s) of the fluorescence signal 114 and the reference pulse 118 that undergo HOM-interference at the beam splitter 110, e.g., the detectors 134a, 134b may be adapted to be particularly sensitive to wavelengths in the range selectively passed by the first and second spectral filters 124a, 124b.

The apparatus 100 further comprises a lifetime detection unit 136 configured to receive, as inputs, first and second detection signals output from the first and second photon detectors 134a, 134b and determine a fluorescence lifetime of the sample based on these first and second detection signals. The lifetime detection unit 136 may comprise a correlator configured to determine a correlation function between the first detection signal received from the first detector 134a and the second detection signal received from the second detector 134b. Preferably, the correlation function is a second-order correlation function. In other words, preferably, the correlation function is a determination of the correlation between a first intensity being indicative of a number of photons received per second by the first detector 134a, and a second intensity being indicative of a number of photons received per second by the second detector 134b.

In order to determine the fluorescence lifetime of the sample, it is preferable to scan across a range of delay times between the fluorescence signal 114 and the reference pulse 118. In other words, it may be preferable to determine a correlation function that provides information of the correlation between the first and second intensity across the full fluorescence lifetime of the sample. This may be achieved by effectively using the reference pulse 118 as a probe that interacts with the fluorescence signal 114. In order to accurately and reliably determine the fluorescence lifetime of the sample, therefore, it is necessary for the duration of the reference pulse 118 to be shorter (sometimes at least 10 times shorter, other times only slightly shorter) in duration than the total fluorescing lifetime of the sample.

In practice probing the full extent of the fluorescence signal 114 with the reference pulse 118 is achieved by adjusting the path length of the first arm 108a relative to the second arm 108b. In some examples, such as that depicted in FIG. 1, this adjustment is achieved by mounting the second fibre coupler 120b to a translation stage 138, although other delay mechanisms are also available and can be used in the context of the apparatus 100 disclosed herein. The translation stage may, therefore, move the second fibre coupler 120b back and forth to adjust the length of the second arm 108b. In this way, the time delay between the arrival of the fluorescence signal 114 and the reference pulse 118 at the beam splitter 110 can be adjusted so that the reference pulse 118 can probe the fluorescence signal 114 across the whole fluorescing lifetime of the sample.

Overall, therefore the lifetime determination unit 136 may be configured to, for each position of the translation stage 138 for which first and second detection signals corresponding to HOM-interference of the fluorescence signal 114 with the reference pulse 118 are collected by the first and second photon detectors 134a, 134b, determine a (second-order) correlation between the first and second detection signal, and consequently determine a (second-order) correlation between the number of photons received per second at each of the first and second photon detectors 134a, 134b as a function of the delay between the arrival of the fluorescence signal 114 and the reference pulse 118 at the beam splitter 110. As discussed above, this delay in arrival is the time delay arising from adjusting the length of the second arm 108b relative to the first arm 108a.

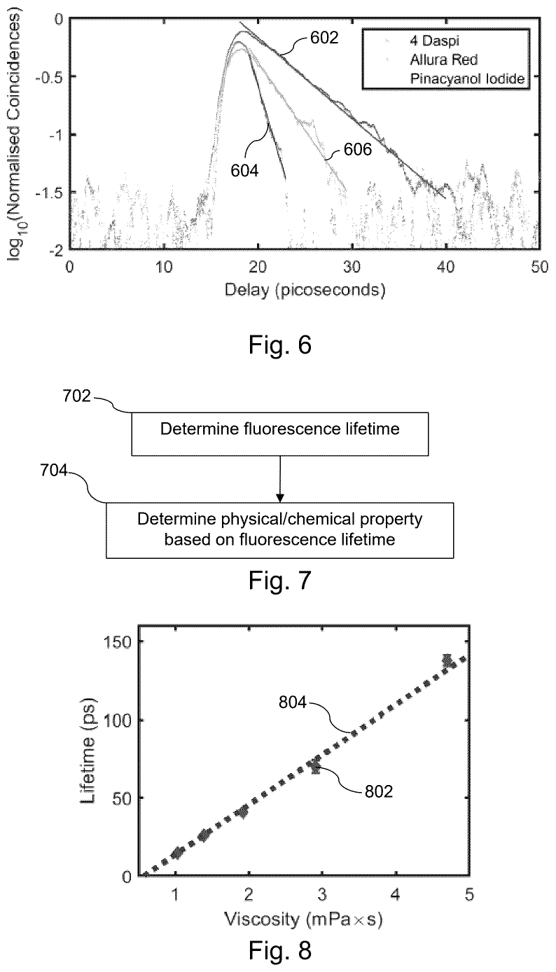

In a particular example, such as that shown in FIG. 1, the arrangement of the apparatus may be suitable for determining the fluorescence lifetime of different sample species. For example, data presented herein (see below with reference to FIG. 6) demonstrates that the apparatus 100 depicted in FIG. 1 is suitable for analysing the fluorescence lifetime of trans-4-[4-(Dimethylamino)styryl]-1-methylpyridinium iodide (hereinafter 4-DASPI), Disodium 6-hydroxy-5-[(2-methoxy-5-methyl-4-sulfophenyl)azo]-2-naphthalenesulfonate (hereinafter Allura Red AC), and pinacyanol iodide, amongst other species. Methods of preparing these samples are expanded upon below in relation to FIG. 6.

One implementation of the apparatus 100 shown in FIG. 1 includes providing the light source 104 as a single femtosecond laser source running at an 80 MHz repetition rate. The excitation pulse 126 has a fixed wavelength of 1040 nanometres and a pulse duration of 140 femtoseconds. This excitation pulse 126 is frequency-doubled in a BBO crystal 128 to a wavelength of 520 nanometres and focused onto a sample mounted on the stage 102 using a microscope objective lens 122 having a magnification factor of 60 and a numerical aperture of 0.7. The fluorescence signal 114 emitted from the sample is collected along the same beam path as the excitation pulse 126 in a confocal geometry and is collimated by the objective lens 122. The excitation pulse 126 is prevented from reaching the first arm 108a of the Mach-Zender interferometer 106 by reflection at a dichroic beam splitter 132, while the fluorescence signal 116 propagates through the dichroic beam splitter 132 towards the first arm 108a. The fluorescence signal 114 is spatially filtered by coupling the fluorescence signal 114 into a single-mode polarisation maintaining fibre of the first arm 108a by a first fibre coupler 120a. Further, a first spectral filter 124a placed between the dichroic beam splitter 132 and the first fibre coupler 120a selects a spectral band around a central wavelength of 660 nanometres. The selected spectral band may have a bandwidth of 0.6 nanometres in some examples, or 10 nanometres in other examples. Other bandwidths for the selected spectral band are also possible, and an appropriate bandwidth may be selected based on the need of the user and the specific fluorophore under investigation.

Meanwhile, the light source 104 (that is the same femtosecond laser source that generated the excitation pulse 126) emits a reference pulse 118 that is tuned to the central wavelength of the first spectral filter 124a, i.e., 660 nanometres. The reference pulse 118 is then propagated through a second spectral filter 124b and a second fibre coupler 120b into the second arm 108b of the Mach-Zender interferometer 106. The second arm 108b is defined by a single-mode polarisation-maintaining optical fibre, and the second fibre coupler 120b and second spectral filter 124b are respectively identical (at least functionally) to the first fibre coupler 120a and first spectral filter 124a.

Both the first and second arms 108a, 108b are then directed towards opposing faces of the splitting surface 116 of a 50:50 beam splitter 110, and photon correlations (when the apparatus 100 is in use) are measured between the two outputs of the beam splitter 110, as measured by the first and second photon detectors 134a, 134b. In the example, shown in FIG. 1, the first and second photon detectors 134a, 134b are a pair of identical SPADs. The first and second detection signals output from the first and second photon detectors 134a, 134b may then be collected by a lifetime detection unit 136 that may take the form of a Time Correlated Single Photon Counting (TCSPC) unit that is configured to determine a correlation between the first and second detection signal.

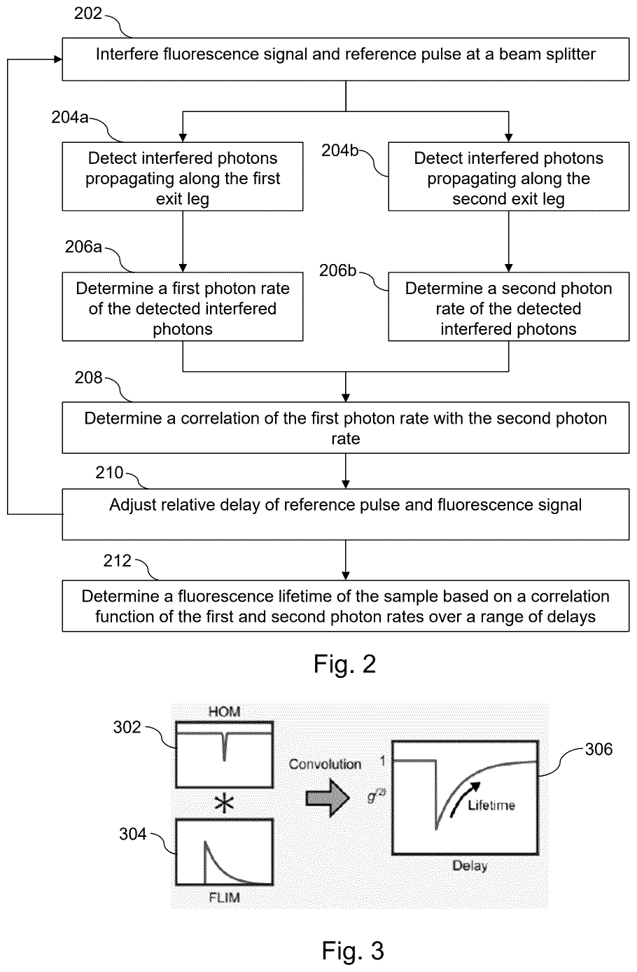

FIG. 2 shows a method for determining the fluorescence lifetime of a sample. The method relates to a fluorescence signal 114 received at a beam splitter 110 along a first arm 108a of a (Mach-Zender) interferometer 106, and a reference pulse 118 received at the beam splitter 110 along a second arm 108b of the interferometer 106, said reference pulse 118 having a frequency selected to interfere with the fluorescence signal 114.

In an operation 202, the beam splitter 110 interferes the fluorescence signal 114 with the reference pulse 118 and outputs a first combined signal from a first output along a first exit leg 112a of the interferometer 106, and a second combined signal from a second output along a second exit leg 112b of the interferometer 106.

In further operations 204a, 204b, first and second photon detectors 134a, 134b detect interfered photons propagating through the first and second exit legs 112a, 112b of the interferometer 106. In response to receiving the outputs of the beam splitter 110, the first and second photon detectors 134a, 134b respectively output first and second detection signals.

Based on the first and second detection signals, in further operations 206a, 206b, the number of photons received per second by the first photon detector 134a, and the number of photons received per second by the second photon detector 134b may be determined. The number of photons received per second by the first photon detector 134a may be referred to as a first photon rate, and the number of photons received per second by the second photon detector 134b may be referred to as a second photon rate.

In a further operation 208, a correlation of the first photon rate with the second photon rate is determined, for example by a correlator of the lifetime determination unit 136 of the apparatus 100.

In a further operation 210, a relative delay of the fluorescence signal 114 and the reference pulse 118 is adjusted. This adjustment may be carried out, for example, by adjusting the relative path length of the second arm 108b of the interferometer 106 relative to the first arm 108a by adjusting a translation stage 138 of the apparatus 100.

Following adjustment of the relative delay, operations 202 to 208 may be repeated to determine a further correlation based on a further fluorescence signal 114 and further reference pulse 118. The adjustment of the relative delay in operation 210 may be repeated as many times as necessary to obtain a full scan of correlations between the first and second photon rates across a range of values for the delay between the fluorescence signal 114 and the reference pulse 118.

Once a full scan of different delay values has been completed, and corresponding correlations between the respective first and second photon rates have been determined, a complete correlation function can be considered to have been determined. This correlation function represents the relationship between the degree of correlation between the first and second photon rates and the delay between the fluorescence signal 114 and the reference pulse 118.

Finally, in operation 212, the fluorescence lifetime of the sample is determined based on the complete correlation function. In preferred examples, the fluorescence lifetime may be readily extracted from the complete correlation function based on identifying a decay constant of an exponentially decaying component of the complete correlation function.

FIG. 3 shows an example of a typical correlation obtainable by the correlator of the lifetime identification unit 136 of the apparatus 100 shown in FIG. 1.

Due to HOM-interference of indistinguishable photons, when a fluorescence photon HOM-interferes with a reference photon, both of the interfered photons are forced to be output from the beam splitter 110 along the same exit leg 112a, 112b. In this way, the coherence of the first and second detection signals suffers from a significant dip at the time at which the HOM-interference occurs. Accordingly, the correlation function 302 for HOM interference exhibits a characteristic dip, sometimes referred to as a HOM dip.

Meanwhile, the fluorescence signal 114 emitted from a fluorescing sample emits the fluorescence according to a characteristic exponentially decaying temporal profile. Under normal circumstances (i.e., with no interference), the correlation function 304 for the fluorescence signal 114 will exhibit full coherence with an intensity that matches the exponential decay.

Overall, therefore, the final complete correlation function 306 can be considered to be a convolution of the characteristic HOM dip 302 with the characteristic exponentially decaying fluorescent emission profile 304. From this convolved correlation function 306, the fluorescence lifetime of the sample can be readily extracted from the exponentially decaying element of the function, not least because the visibility of this feature is enhanced by the HOM dip 302.

As an example, the fluorescence lifetimes is preferably measured by the second-order correlations, also referred to as g⁽²⁾ correlations that are sampled by the HOM dip. In this way the HOM dip effectively acts as an effective impulse response function (IRF) of the timing system for the apparatus 100 shown in FIG. 1.

In practice, this effective IRF can be approximated by performing a linear auto-correlation of the reference pulse 118. This auto-correlation can be carried out by placing a 50:50 beam splitter between the light source 104 and the second fibre coupler 120b. The reflection from the 50:50 beam splitter is coupled into another fibre that replaces the first arm 108a of the Mach-Zender interferometer, thereby replacing the fluorescence signal 114. Determining the auto-correlation then comprises measuring the photon count at one of the first and second photon detectors 134a, 134b as a function of the position of the translation stage 138 (i.e., a function of the delay between the replacement first arm and the second arm 108b). A low pass filter can then be applied to the resulting interference pattern to remove the coherent fringes output from the beam splitter 110 and retrieve the auto-correlation envelope function.

The second-order correlation function between the first and second detection signals may be expressed as:

$${g}^{( 2 )} ( {t}^{′} ) = \frac{〈 {I}_{1} ( t ) {I}_{2} ( t + {t}^{′} ) 〉}{〈 {I}_{1} ( t ) 〉 〈 {I}_{2} ( t + {t}^{′} ) 〉}$$

where g⁽²⁾(t′) is the value of the second-order correlation function at a time t′, I₁(t) is the intensity measured at the first photon detector 134a at a time t, and I₂(t+t′) is the intensity measured at the second photon detector 134b at a time t+t′.

Clearly, therefore, determining the second-order correlation function requires an understanding of the temporal intensity profile of the fluorescence signal 114 and the reference pulse 116. The intensity profile of the reference pulse is easily extracted and known as the intensity profile output from the light source 104. Meanwhile, the temporal intensity profile of the fluorescence signal 114 be determined as a convolution of the intensity profile Iₑₓ(t) of the excitation pulse 126 and the fluorescent response F(t) of the sample:

$${I}_{FP} ( t ) = {I}_{ex} ( t ) \times F ( t )$$

where:

$$F ( t ) = A {e}^{- 𝔱 / μ}$$

where A is an amplitude determined by the excitation cross-section and emission efficiency of the fluorescence, and μ is the decay constant i.e., the fluorescence lifetime of the sample. Based on these formulae, it is possible to determine the normalised number of coincident photon pair events C(τ) for an optical delay τ between the two arms 108a, 108b of the interferometer 106:

$$C ( τ ) = 1 - {C}_{0} {e}^{( {σ}^{2} - 2 μ τ / {μ}^{2} )} {erfc ( \frac{{σ}^{2} - μ τ}{\sqrt{2} μ σ} )}^{2}$$

where σ is the temporal duration of the reference pulse 118 (in this case ˜140 femtoseconds), ‘erfc’ is the complementary error function, and C₀ is a constant that encapsulates the visibility of the interference depending on the amplitude of the fluorescence signal 114 compared with the amplitude of the reference pulse 118, their durations, and the transmission constants of the beam splitter 110.

Under the condition that σ<<μτ, i.e., the condition that the reference pulse 118 is much shorter in duration than the fluorescence lifetime of the sample, then this equation can be reduced to:

$$C ( τ ) ∼ 1 - 4 {C}_{0} {e}^{- 2 \frac{2 τ}{μ}}$$

From this equation, it can be observed that, for a sufficiently high temporal resolution of the system (i.e., a sufficiently short reference pulse 118), the fluorescence lifetime of the sample can be measured directly from the number of coincident events (i.e., the number of HOM-interference events), modified by a constant factor of 2. This factor of 2 originates from the fact that the second order correlation function is a product of intensities at each of the photon detectors 134a, 134b, both of which contain a component that includes the fluorescence lifetime of the sample.

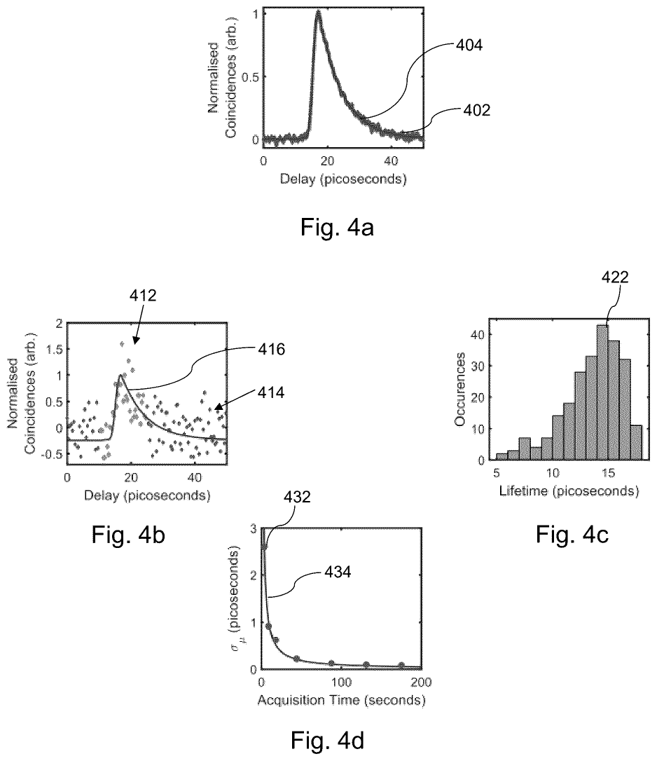

FIG. 4a shows a fluorescence lifetime curve for a 4-DASPI sample determined based on a correlation function obtained from the correlator of FIG. 1. To obtain the results presented in FIG. 4a, a high level of indistinguishability between the photons of the fluorescence signal 114 and the reference pulse 118 was required. This was achieved by using a narrowband 0.6 nanometre full-width-half-maximum spectral filter as the first and second spectral filters 124a, 124b. Implementing such filters had the overall effect of increasing the interference visibility of the interference fringes output from the beam splitter 110 at the expense of reducing the achievable resolution.

The 4-DASPI sample was prepared by dissolving a sample of 4-DASPI in purified water at a concentration of approximately 2.73 millimolar. The sample was imaged at room temperature mounted in 10-millimetre path-length UV-fused quartz cuvettes.

In the example for which results are presented in FIG. 4, typical photon rates received at the first and second photon detectors 134a, 134b were on the order of 1 million photons per second received with a correlated pair event rate of approximately 14,000 photons per second outside of the HOM dip. The data 402 shown in FIG. 4a was obtained with an acquisition time of 2 seconds per delay point, and the number of coincident events was normalised to the total number of photon counts over the entire acquisition time to remove any fluctuations arising from variations in the laser power and/or fibre coupling. The step size on the translation stage 138 between consecutive measurements was equivalent to a step change in the optical delay between the fluorescence signal 114 and the reference pulse 118 of 16.7 femtoseconds. The fitted line 404 fitted to the data 402 yields a determined fluorescence lifetime of 14.45±0.07 picoseconds. It is noted that the data 402 shown in FIG. 4a is of much lower noise and vastly over-sampled compared to typical time domain FLIM measurements.

FIG. 4b shows a fluorescence lifetime curve for the same 4-DASPI sample as plotted in FIG. 4a determined based on a correlation function obtained from the correlator of the lifetime determination unit 136 of FIG. 1, wherein the total acquisition time for the entire correlation was just 3.5 seconds.

Here, only a portion 412 of the data centred around the fluorescence peak was considered for the purpose of fitting the data, the remainder of the data 422 was not considered for fitting purposes.

In the example shown in FIG. 4b, a Markov Chain Monte Carlo approach was used for lifetime retrieval. This approach may include using the Imfit package in Python to fit the experimental data to the equation set out above by solving the non-linear least squares regression problem with the Levenberg-Marquardt algorithm. As a consequence, the parameter space around the best-fit solution was explored by implementing the Affine Invariant Markov Chain Monto Carlo Ensemble sample in Imfit via a Minimizer.emcee( ) method. This allowed the refinement of the initial least squares estimate. The sampling rate of the lifetime curves that were deconvolved using this approach were one-tenth of that of the curves obtained using long acquisition times, and simultaneously a smaller delay region was sampled where the experimental noise is lowest to reduce the total acquisition time. For the lifetime curve shown in FIG. 2b, this meant that the fluorescence peak was sampled with only 35 stage points, resulting in an overall acquisition time of just 3.5 seconds.

The fit 416 to the data 412 shown in FIG. 2 thereby provided a reliable determination of the fluorescence lifetime of the sample as 13.6 picoseconds.

FIG. 4c shows a distribution of retrieved lifetimes for 300 determined fluorescence lifetimes of 4-DASPI determined using the same parameters as exemplified above in relation to FIG. 4b. From the histogram 422 it can be deduced that fluorescence lifetime of 4-DASPI is determined with a mean value of 13.6 picoseconds and a standard deviation of 2.6 picoseconds.

FIG. 4d shows a determined relationship between the standard deviation of the determined fluorescence lifetime and the total measurement acquisition time. From the data 432 plotted in FIG. 4d, a function 434 can be fitted that takes the form of:

$$σ ∝ Acquisition {Time}^{- 1. \pm 0.14}$$

Accordingly, it can be seen that the standard deviation in the determined fluorescence lifetime is inversely proportional to the total acquisition time over which the complete correlation function is determined. Based on the data plotted in FIG. 4d, it is determined that the total acquisition time should be at least 20 seconds. With acquisition times longer than 20 seconds, there is a diminishing return in the improvement of the standard deviation, and so 20 seconds may be considered to be an optimum total acquisition time.

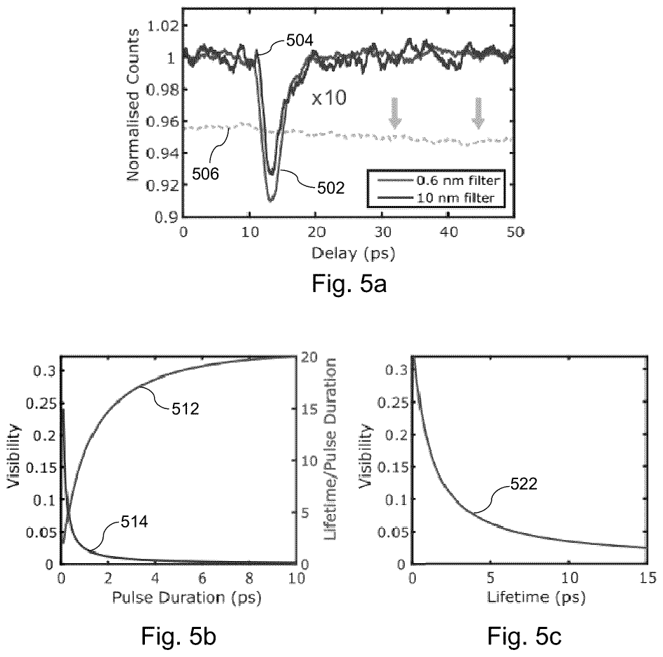

FIG. 5a shows a plot demonstrating the effect of spectral filtering for two different bandwidths, as applied to an Allura Red sample.

A sample of Allura Red was prepared for these measurements by dissolving a sample of Allura Red in purified water to a concentration of approximately 5.04 millimolar. The sample was imaged at room temperature mounted in 10-millimetre path-length UV-fused quartz cuvettes.

The plot shown in FIG. 5a compares a first plot 502 of the normalised photon count value when spectral filters 124a, 124b with a bandwidth of 0.6 nanometres were implemented with a second plot 504 of the normalised photon count value when spectral filters 124a, 124b with a bandwidth of 10 nanometres were implemented. For illustrative purposes the amplitude of the signal for the second plot 504 has been multiplied by 10 to aid comparison. All other parameters were fixed during the acquisition runs corresponding to the first and second plots 502, 504. Additionally, a third plot 506 (shifted down) of the normalised single photon counts received at one of the photon detectors 134a, 134b is presented. This third plot corresponds to the same data acquisition run as the first plot 502.

It can clearly be seen from the second plot 504, that the temporal overlap between the fluorescence signal 114 and the reference pulse 118 remains low due to the relatively large difference between the 1340 femtosecond reference pulse 118 duration and the much longer 3.2 picosecond duration of the Allura red lifetime (see below with reference to FIG. 5). Meanwhile, the maximum temporal overlap corresponding to the first plot 502 is much higher as a 0.6 nanometre bandwidth corresponds to a transform limited pulse of order 1 picosecond duration. This, therefore, improves the temporal overlap of the reference pulse 118 with the fluorescence signal 114 and improves the visibility of the HOM-interference dip at the expense of resolution (because the reference pulse 118 has been transform limited to ˜1 picosecond by the narrow-band spectral filter 124b).

From the third plot 506, it can be clearly seen that there are no interference fringes in the individual photon detector 134a, 134b, thus confirming that the apparatus 100 is being used in a regime where there is no first order interference (i.e., the interference is dominated by HOM-interference).

FIG. 5b shows a plot indicating how the pulse duration of the reference beam 118 affects the visibility of the HOM-interference fringes output from the Mach-Zender interferometer 106 of FIG. 1, and a relationship between the pulse duration of the reference pulse 118 and the fluorescence lifetime of the sample.

The first plot 512 shown in FIG. 5b of reference pulse duration vs. HOM-interference visibility shows that the HOM-interference visibility increases with the pulse duration of the reference pulse 118. Meanwhile, the second plot 514 shown in FIG. 5b of reference pulse duration vs. fluorescence lifetime/pulse duration is effectively a plot of reference pulse duration vs. temporal resolution because the ratio of the fluorescence lifetime to the pulse duration is a measure of the resolution of the methods disclosed herein. Accordingly, it can be seen from FIG. 5b that there is a trade-off between the maximum achievable temporal resolution and the maximum achievable HOM-interference visibility. For the purposes of demonstrating this effect in FIG. 5b, the fluorescence lifetime of a sample has been fixed at 1 picosecond, and the visibility and resolution have been modelled across a range of reference pulse 118 durations. Based on the modelling presented in FIG. 5b, it can be seen that an optimum compromise between visibility and resolution may be achieved when the duration of the reference pulse 118 is slightly shorter than the fluorescence lifetime of the sample.

FIG. 5c shows a plot indicating a relationship between the fluorescence lifetime of the sample and the visibility of HOM-interference fringes output from the beam splitter 110 of the Mach-Zender interferometer 106 in FIG. 1. FIG. 5c has been modelled based on a reference pulse 118 duration of 100 femtoseconds. From FIG. 5c it can also be seen that the visibility of the HOM-interference fringes decreases with increasing fluorescence lifetime.

To demonstrate the applicability of the methods and apparatus disclosed herein across different samples, FIG. 6 shows fluorescence lifetimes determined for different samples.

A first plot 602 of FIG. 6 shows a log of the normalised coincidence counts determined by the lifetime determination unit 136 across a range of time delays for a sample of 4-DASPI. As above, the sample of 4-DASPI was prepared by dissolving 4-DASPI in purified water to a concentration of 2.73 millimolar. The sample was imaged at room temperature mounted in 10-millimetre path-length UV-fused quartz cuvettes. From the first plot 602, a fluorescence lifetime of 14.45 picoseconds for 4-DASPI can be determined.

A second plot 604 of FIG. 6 shows a log of the normalised coincidence counts determined by the lifetime determination unit 136 across a range of time delays for a sample of Allura Red. As above, the sample of Allura Red was prepared by dissolving Allura Red in purified water to a concentration of 5.04 millimolar. The sample was imaged at room temperature mounted in 10-millimetre path-length UV-fused quartz cuvettes. From the second plot 604, a fluorescence lifetime of 3.2 picoseconds for Allura Red can be determined.

A third plot 606 of FIG. 6 shows a log of the normalised coincidence counts determined by the lifetime determination unit 1365 across a range of time delays for a sample of pinacyanol iodide. The pinacyanol iodide sample was prepared by dissolving pinacyanol iodide in methanol to a concentration of approximately 0.12 millimolar. The sample was imaged at room temperature mounted in 10-millimetre path-length UV-fused quartz cuvettes. From the third plot 606, a fluorescence lifetime of 7.3 picoseconds for pinacyanol iodide can be determined.

In addition to determining fluorescence lifetimes of various samples, other physical and/or chemical properties of the samples can be inferred based on the determined fluorescence lifetime. This presents an opportunity to non-invasively (and therefore non-disruptively) analyse nanoscale samples. Prior art examples of nanoscale samples are typically invasive and therefore highly disruptive, or even destructive, to the samples. For example, nano-rheology (the measurement of nano-scale viscosities) typically uses atomic force microscopy, where a metal tip is placed in contact with the sample. Such an approach is clearly not suitable for remote or contact-free measurements and is a particularly invasive means of analysis.

FIG. 7 shows a method of determining physical and/or chemical properties of a fluorescent sample non-invasively. In a first operation 702, the fluorescence lifetime of the sample is determined (preferably by implementing the method of FIG. 2, as described above). In a further operation, the physical and/or chemical property of interest is determined (or inferred) based on this determined fluorescence lifetime.

As an example, the fluorescence lifetime of 4-DASPI has been found to depend on temperature and vary between 9 and 12.5 picoseconds dependent on temperature.

Similarly, the viscosity of 4-DASPI has been seen, based on measurements carried out by the inventors, to affect the fluorescence lifetime of 4-DASPI.

FIG. 8 shows a plot demonstrating a relationship between viscosity and fluorescence lifetime for a sample of 4-DASPI mixed with glycerol. Previous attempts to link fluorescence lifetime and viscosity have only succeeded at very high viscosities where the sample is almost purely glycerol. In contrast, the methods disclosed herein enable determination of fluorescence lifetimes at much shorter times than have been previously achievable, and so viscosity determinations at much lower viscosities are consequently achievable.

The samples analysed according to the methods disclosed herein and presented in FIG. 8 were prepared by varying the weight concentration of glycerol dissolved in purified water with a fixed amount of 4-DASPI of 0.1% by weight. Before analysis, the glycerol-water-4-DASPI solution was titrated to a pH of 7.0 while being continuously mixed.

The viscosity of the samples was verified using a rheometer according to known methods to be able to plot data points 802 of the viscosity of the samples vs. their determined fluorescence lifetimes. Based on this data, it was possible to fit a function 804 relating viscosity to fluorescence lifetime. It is therefore possible, once the fluorescence lifetime of a sample is determined to infer its viscosity from the plot of FIG. 8.

Importantly, when acquiring the data for FIG. 8, more than an order of magnitude variation in the fluorescence lifetime can be seen across the range of tested viscosities. In contrast, no appreciable change was detected in the photon count levels in either of the photon detectors 134a, 134 thereby indicating that the fluorescence lifetime of the sample is a much more sensitive probe for determining viscosity than simple intensity measurements.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. An apparatus for determining a fluorescence lifetime of a sample, the apparatus comprising:
an interferometer, the interferometer comprising:
a first arm for conveying a fluorescence signal from the sample;
a second arm for conveying a reference pulse, wherein the reference pulse has a frequency selected to interfere with the fluorescence signal;
a delay mechanism configured to control a relative path delay between the first and second arms; and
a beam splitter having a first input connected to the first arm, a second input connected to the second arm, a first output configured to emit a first combined signal, and a second output configured to emit a second combined signal;
a first photon detector connected to the first output so as to receive the first combined signal and output a first detection signal indicative of a number of photons in the first combined signal;
a second photon detector connected to the second output so as to receive the second combined signal and output a second detection signal indicative of the number of photons in the second combined signal; and
a lifetime determination unit connected to the first and second photon detectors, wherein the lifetime determination unit is configured to determine the fluorescence lifetime of the sample based on a correlation between the first and second detection signals over a range of relative path delays between the first and second arms.

2. The apparatus according to claim 1, wherein the reference pulse has a duration that is shorter than the fluorescence lifetime to be determined.

3. The apparatus according to claim 1, wherein the lifetime determination unit comprises a correlator connected to the first and second photon detectors, the correlator being configured to determine a correlation function of the first detection signal with the second detection signal.

4. The apparatus according to claim 3, wherein the correlation function is a second-order correlation function.

5. The apparatus according to claim 1, wherein the first arm and the second arm each comprise a respective optical fibre, wherein the first arm comprises a first fibre coupler configured to couple the fluorescence signal into a corresponding optical fibre, wherein the second arm comprises a second fibre coupler configured to couple the reference pulse into the corresponding optical fibre, and wherein the delay mechanism comprises at least one of the first and second fibre couplers mounted on a translation stage.

6-7. (canceled)

8. The apparatus according to claim 1, wherein the first combined signal is conveyed from the beam splitter to the first photon detector by an optical fibre, and wherein the second combined signal is conveyed from the beam splitter to the second photon detector by an optical fibre.

9. The apparatus according to claim 5, wherein at least one of the optical fibres is a single-mode polarisation-maintaining fibre.

10. The apparatus according to claim 1, further comprising first and second spectral filters configured to selectively tune a wavelength of the respective signals conveyed towards the beam splitter via the first and second arms, wherein the first and second spectral filters are configured to selectively tune the wavelength of the respective signals to a same wavelength.

11. The apparatus according to claim 1, further comprising a reference light source configured to emit the reference pulse.

12. The apparatus according to claim 1, further comprising an excitation light source configured to emit an excitation pulse along an input beam path for inducing fluorescence in the sample.

13. The apparatus according to claim 12, wherein the fluorescence signal is conveyed from the sample to the first arm along the input beam path, and wherein the apparatus further comprising a dichroic filter on the input beam path, wherein the dichroic filter is configured to prevent the excitation pulse from propagating into the first arm, and to allow the fluorescence signal to propagate into the first arm.

14. (canceled)

15. The apparatus according to claim 11, wherein the reference light source is also operable as an excitation light source configured to emit an excitation pulse along an input beam path for inducing fluorescence in the sample.

16. The apparatus according to claim 11, wherein the reference light source is a single photon source.

17. The apparatus according to claim 11, wherein the reference light source is a laser.

18. The apparatus according to claim 11, wherein:
the first arm is configured to convey the fluorescence signal towards a first face of a splitting surface in the beam splitter;
the second arm is configured to convey the reference pulse towards a second face of the splitting surface in the beam splitter, wherein the beam splitter is configured to interfere the reference pulse and the fluorescence signal; and
the first and second combined signals comprise interfered photons from emitted from the first and second faces of the splitting surface respectively.

19. A method of determining a fluorescence lifetime of a sample, the method comprising:
receiving, at a beam splitter along a first arm of an interferometer, a fluorescence signal from the sample;
receiving, at the beam splitter along a second arm of the interferometer, a reference pulse, wherein the reference pulse has a frequency selected to interfere with the fluorescence signal;
interfering, by the beam splitter, the fluorescence signal with the reference pulse, wherein the beam splitter outputs a first combined signal from a first output and a second combined signal from a second output
outputting, by a first photon detector that receives the first combined signal, a first detection signal indicative of a number of photons in the first combined signal;
outputting, by a second photon detector that receives the second combined signal, a second detection signal indicative of the number of photons in the second combined signal; and
determining the fluorescence lifetime of the sample based on a correlation between the first and second detection signals over a range of relative path delays between the first and second arms of the interferometer.

20. The method according to claim 19, wherein determining the fluorescence lifetime of the sample comprises determining a correlation function of the first detection signal with the second detection signal.

21. (canceled)

22. The method according to claim 20, wherein the determined correlation function comprises an exponentially decaying element, and the determined fluorescence lifetime of the sample is determined based on a decay constant of the exponentially decaying element.

23. The method according to claim 19, wherein determining the fluorescence lifetime comprises:
adjusting the relative path delay between the first arm and the second arm; and
collecting the first and second detection signals for each of a plurality of different relative path delays.

24. The method of according to claim 19, further comprising:
determining a property of the fluorescent sample based on the determined fluorescence lifetime, wherein the determined property is one or more of the properties selected from the group comprising: pH, temperature, viscosity, and chemical concentration.

25. (canceled)
